(19) United States
(12) Patent Application Publication
(10) Pub. No.: US 2014/0082275 A1
(43) Pub. Date: Mar. 20, 2014

(54) SERVER, HOST AND METHOD FOR READING BASE IMAGE THROUGH STORAGE AREA NETWORK

(71) Applicants: INVENTEC (PUDONG) TECHNOLOGY CORPORATION, Shanghai (CN); INVENTEC CORPORATION, Taipei (TW)

(72) Inventor: Hong Su ZHANG, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/792,435

(22) Filed: Mar. 11, 2013

(30) Foreign Application Priority Data
Sep. 18, 2012 (CN) 201210348063.7

(51) Int. Cl. G06F 3/06

(52) U.S. Cl. CPC G06F 3/067; G06F 3/065
USPC 711/112

(57) ABSTRACT

A server, a host and a method for reading the base image through a storage area network (SAN) are provided. A setting host builds a parent virtual hard disk (VHD) in a storage server through an SAN. The parent VHD is used as a base image to build a difference VHD in a local disk by the service host. After a virtual machine (VM) operated on the service host mounts the difference VHD and when the VM executes a target program, the service host reads original data in the parent VHD through the SAN and accesses difference data generated by the target program in the difference VHD in the local disk. The server, the host and the method can configure base image and difference VHD on different devices, and can achieve the effect of increasing access performance and number of supported VMs of the storage server.

### BACKGROUND OF THE INVENTION

1. Field of Invention

The invention relates to a server, a host, and a method for reading the base image. In particular, the invention relates to a server, a host, and a method for a virtual machine to read the base image through a storage area network.

2. Related Art

Users doing same work usually use exactly the same operating environment. For the convenience of management, as well as to avoid the need to install the operating system (OS) and applications individually for each user, one often adopts the virtual machine (VM) solution nowadays. Managers first install a copy of the initial operating environment, which is used as the base image of the user's VM. The VM is then mounted with the difference disk established upon the base image. Therefore, all the VM's share the OS and applications in the base image. Afterwards, as the VM runs, the difference data thus generated are stored in the difference disk mounted in the VM. This means that the difference disk access can be very frequent.

Most of current common systems set the shared base image and the difference disk accessed solely by the VM on a remote storage server. The VM accesses data from the base image and the difference disk in the storage server. As a result, when all the VM's access the data, the access load concentrates on the storage server. Such an access load is quite high for the storage server, resulting in low access performance. At the same time, the storage server also requires a lot of storage space to store multiple difference disks. In addition, the host of the VM continuously sends and receives data over the network. This is large network resources consumption. Therefore, some systems build the base image and the difference disk on the same host. Although this configuration can reduce the consumption of network resources, the access load is still concentrated on the host. The access performance remains low. The base image cannot be shared, either.

In summary, the prior art has the problem of poor performance because the base image and the difference disk set are installed on the same device. It is imperative to provide improved techniques to solve this problem.

### SUMMARY OF THE INVENTION

In view of the foregoing problems, the invention discloses a serve, a host, and a method for reading the base image through a storage area network (SAN).

The disclosed server for reading the base image through the SAN includes at least: a storage media to store a parent virtual hard disk (VHD) file that contains a target program; a target module that allows the host to mount the storage media through the SAN as a remote disk. The host takes the parent VHD to establish a difference VHD file for the base image. When the VM running on the host uses the corresponding difference VHD file to execute the target program, the target program is sent to the host.

The disclosed host for reading the base image through the SAN includes at least: an initiator, a local disk, and a VM processing module. The initiator mounts the storage media of the storage server as a remote disk via the SAN. The storage media stores a parent VHD file that contains the target program. The initiator also downloads the target program. The local disk stores the difference VHD file. Each difference VHD file is established by using the parent VHD file as the base image. The VM processing module executes the VM corresponding to the difference VHD file so that the VM executes the target program. When the VM reads data related to the target program, the VM processing module reads the related data from the difference VHD file corresponding to the VM. When the target program stores the generated difference data, the difference data are stored in the difference VHD corresponding to the VM.

The disclosed method for reading the base image through the SAN includes at least the steps of: mounting a storage server as a remote disk through the SAN by the host; setting the host to establish a parent VHD file on the remote disk; using the parent VHD file as a base image by a service host and establishing a difference VHD file in the local disk of the service host; executing the VM corresponding to the difference VHD by the service host; mounting the corresponding difference VHD file on the VM; executing the target program in the parent VHD file by the VM via the corresponding difference VHD file; reading related data from the difference VHD file corresponding to the VM by the service host when the VM reads the related data of the target program; accessing difference data in the difference VHD file corresponding to the VM by the service host when the target program accesses the generated difference data.

The disclosed system and method differ from the prior art in that the disclosed host establishes the parent VHD file in the storage server through the SAN. The parent VHD file is used as the base image to build the difference VHD file on the local disk. After the VM running on the host mounts the difference VHD file and when the VM executes the target program, the service host reads the original data in the parent VHD file via the SAN, and access the difference data generated by the target program in the difference VHD file of the local disk. This solves problems existing in the prior art. It also achieves the effect of enhancing the access performance of the storage server and increasing the number of VM's supported by the storage server.

### BRIEF DESCRIPTION OF THE DRAWINGS

The invention will become more fully understood from the detailed description given herein below illustration only, and thus is not limitative of the present invention, and wherein:

FIG. 1 is a schematic view of the server for reading the base image through the SAN.

FIG. 2 is a schematic view of the host for reading the base image through the SAN.

FIG. 3A is a flowchart of the method for reading the base image through the SAN.

FIG. 3B is a flowchart of one way to establish a parent VHD file.

FIG. 3C is a flowchart of another way to establish a parent VHD file.

FIG. 3D is a flowchart of setting the initial environment.

FIG. 3E is a flowchart of combining the target program downloaded from the host cache.

FIG. 3F is a flowchart of combining the target program read from the server cache.

### DETAILED DESCRIPTION OF THE INVENTION

The present invention will be apparent from the following detailed description, which proceeds with reference to the accompanying drawings, wherein the same references relate to the same elements.

The invention sets the parent VHD file as a base image in a storage server, and sets the difference VHD file on a host. The VM's running on the hosts share a common base image. The difference data generated by the running VM are stored in a difference VHD file. This can effectively reduce the I/O load of the storage server.

The storage server further includes cache. The host may also include host cache. The base image access speed of the host can be increased via the server cache and/or host cache. The host cache can further reduce the network flow as the host access the base image.

We first describe how the disclosed system operates. The disclosed system includes at least one storage server and a plurality of hosts. It should be mentioned that the number of hosts is usually determined by the users of the system. The more users there are, there are more hosts 200. The number of the storage servers 100 is determined by the number of hosts 200. When all the hosts 200 operate normally, if the access performance or the network load of each of the storage servers 100 reaches a certain proportion, one usually has to increase the storage servers 100 while increasing the hosts so that the access performance or the network load of the storage servers 100 does not drop. This in turn affects the data access performance of each of the hosts.

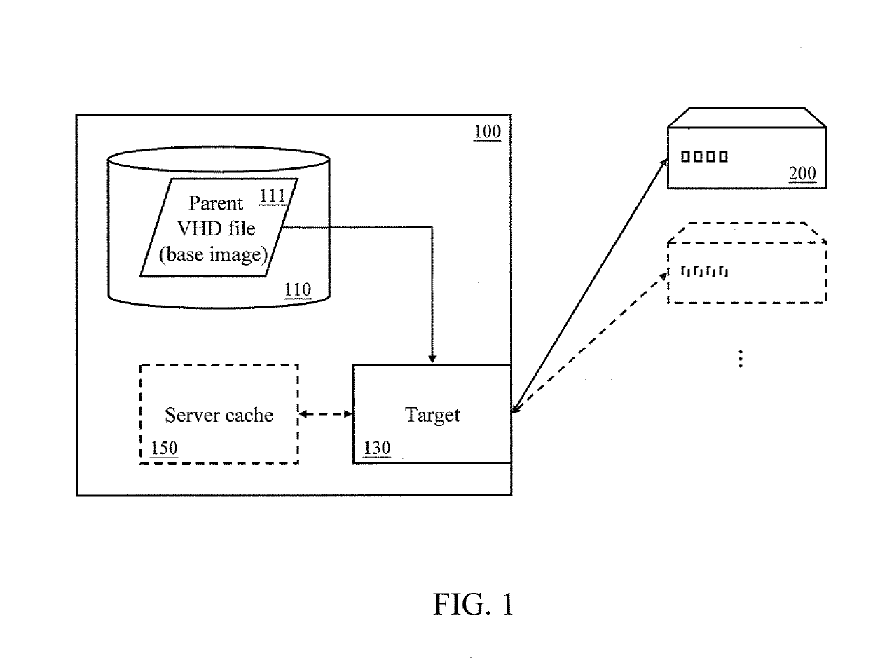

FIG. 1 shows the elements of the disclosed server for reading the base image through the SAN. The storage server 100 includes a storage media 110, a target 130, and an appendable server cache 150.

The storage media 110 stores a parent VHD file 111. The storage media 110 usually refers to a block device that can randomly access chunks of data of specific sizes, such as a hard disk or an optical disk. The invention does not have any restriction on this.

The parent VHD file 111 stored in the storage media 110 in this invention is a read-only file. The parent VHD file 111 usually contains the target program installed on the host 200. However, the invention is not limited to this possibility. In some embodiments, the parent VHD file stored in the storage media 110 can have no target program installed. The target program referred herein includes an OS and applications that can run on the VM. Yet the invention is not limited to this.

The target 130 enables the host 200 to connect with the storage server 100 via the SAN. It allows the host 200 to mount the storage media 110 so that the storage media 110 becomes a remote disk of the host 200.

The target 130 also reads the target program contained in the parent VHD file 111 from the storage media 110, and sends the target program to the host 200. The VM's running on the hosts 200 can all execute the target program. It should be mentioned that if the storage media 110 is a block device, the target program may be stored in multiple blocks. In this case, the target 130 reads the storage blocks of the target program and sends them to the host 200.

The server cache 150 is a storage element appendable to the storage server 100. It is usually a storage device whose reading speed is faster than that of the storage media 110, such as random access memory (RAM), flash memory, etc. However, the server cache 150 is not limited to such possibilities.

The server cache 150 saves the target program read out by the target 130 from the storage media 110. When the target 130 needs to read out the target program from the storage media 110 again, it first determines whether the server cache 150 already stores the target program. If so, it reads the target program directly from the server cache 150. Otherwise, the target 130 reads the target program in the storage media 110. After being read out, the target program is stored in the server cache 150.

If the storage media 110 is a block device, the server cache 150 may not have stored the complete target program. That is, the server cache 150 may not contain all the storage blocks of the target program, but only part of them. In this case, when the target 130 needs to read the target program again, it first determines whether the server cache 150 already stores the storage blocks of the target program. If the server cache 150 stores one or several storage blocks of the target program, the target 130 reads all of the storage blocks of the target program stored in the server cache 150 and the other storage blocks not contained in the server cache 150 from the storage media 110. The storage blocks read out from the storage media 110 are stored in the server cache 150. All of the storage blocks of the target program are then sent to the host 200.

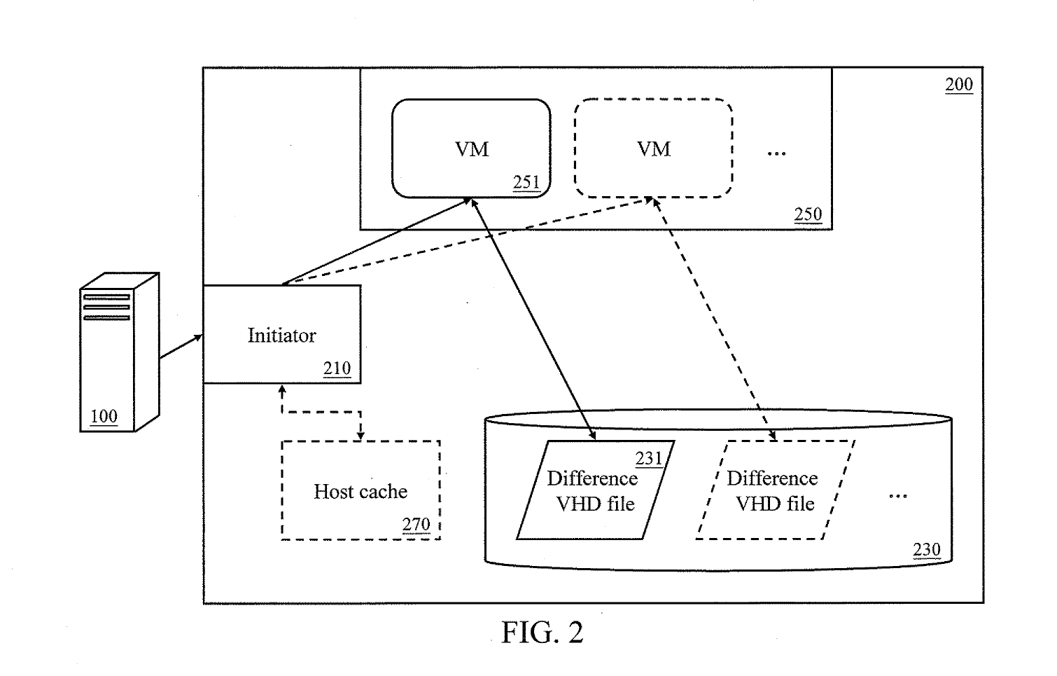

Please refer to FIG. 2 for the interior of the disclosed host for reading the base image through the SAN. The host 200 includes an initiator 210, a local disk 230, a VM processing module 250, and an appendable host cache 270.

The initiator 210 connects to the storage server 100 via the SAN, and mounts the storage media 110 of the storage server 100 as a remote disk thereof. The initiator 210 also downloads the target program in the parent VHD file 111 stored in the storage media 110 from the storage server 100.

The local disk 230 stores the difference VHD file 231. The local disk 230 is similar to the storage media 110 of the storage server 100. It is usually a block device too, but not limited to this case.

The difference VHD file 231 stored in the local disk 230 is established using the parent VHD file 111 as the base image. The local disk 230 of each of the hosts 200 can store one or multiple difference VHD files 231.

It should be mentioned that the parent VHD file 111 is a read-only file. The data generated after appending, modifying, and deleting contents of the parent VHD file 111 are stored in the difference VHD file 231 (the generated data are the difference data referred herein). If the local disk 230 is a block device, then the difference VHD file 231 stores the storage blocks with changes from the parent VHD file 111. That is, the storage blocks containing difference data are stored in the difference VHD file 231.

The VM processing module 250 usually includes a processor and memory, but not limited to such components.

The VM processing module 250 runs VM's 251. The VM processing module 250 of each host 200 can run one or more VM's. The invention does not have any restrictions on this. The VM's 251 run by the VM processing module 250 have one-to-one relations with the difference VHD files 231 stored in the local disk 230.

As the VM processing module 250 runs a VM 251, the VM 251 mounts the corresponding difference VHD file 231 and executes the target program therein. When the VM 251 runs the target program, the VM 251 or the executed target program may need to read data related to the target program, such as its setting file, dynamic link file, and data file (but not limited to these). In this case, if the data related to the target file are the original data in the parent VHD file 111 and the data contents are not changed due to writing, then the VM processing module 250 reads the data related to the target program from the storage media 110 of the storage server 100 through the initiator 210. If the data related to the target program becomes difference data due to such operations as appending, modifying, and deleting, then the changed data are stored in the difference VHD file 231 corresponding to the running VM 251. Therefore, the VM processing module 250 reads data related to the target program from the difference VHD file 231 corresponding to the running VM 251. Besides, when the VM 251 executes the target program, the VM 251 or the running target file may perform writing to produce difference data, such as buffer and cache. The VM processing module 250 stores the difference data thus generated into the difference VHD file 231 corresponding to the running VM 251.

Since the VM is the same as a normal computer, it requires such target programs as OS's and applications in order to operate. Therefore, the VM processing module 250 can further provide the VM 251 to install such target programs.

The VM processing module 250 can generate a temporary VHD file (not shown) without any data on the local disk 230 and execute the VM. After the VM is executed, it mounts the temporary VHD file generated by the VM processing module 250 as the hard disk thereof and formats the hard disk. When the VM installs a target program, the VM processing module 250 stores the installed target program into the temporary VHD file. After the VM completes the installation of the target program, an agent is established for the OS installed in the VM (i.e., the temporary VHD file). After the VM processing module 250 shuts down the VM or the VM unmounts the temporary VHD file generated by the VM processing module 250, the VM processing module 250 copies the VHD file containing the target program and the agent to the remote disk of the host 200, i.e., the storage media 110 of the storage server 100. Thus, the temporary VHD file copied by the VM processing module 250 to the remote disk of the host 200 is the parent VHD file 111 referred herein.

In practice, the method for the VM processing module 250 to install the target program on the VM for establishing a parent VHD file 111 is not limited to the above-mentioned one. The VM processing module 250 can set the initiator 210 of the host to directly generate a parent VHD file 111 on the remote disk (the storage media 110 of the storage server 100) of the host 200. Afterwards, the VM processing module 250 executes the VM as described above. When the VM installs the target program, the installed program is stored to the generated parent VHD file 111. After the VM finishes the target file installation, an agent is established in the OS installed on the VM (i.e., the parent VHD file 111). Consequently, the parent VHD file 111 includes both the target program and the agent.

After the VM processing module 250 establishes the parent VHD file 111, the local disk 230 establishes the difference VHD file 231 according to the parent VHD file 111 and mounts the established difference VHD file 231, thereby writing the data related to the target program into the difference VHD file 231. Thus, when the VM processing module 250 runs the new VM corresponding to the established difference VHD file 231, the new VM first executes the agent in the parent VHD file 111. After the agent is executed by the VM, it follows the data in the difference VHD file 231 to set the initial environment of the new VM so that the target programs of OS and applications of the new VM can operate normally.

The host cache 270 is a storage element appendable to the host 200, such as flash memory and RAM but not limited to such examples. Generally speaking, the access speed of the host cache 270 is faster than the local disk. But the invention does not have any restriction on this.

The host cache 270 stores the target program downloaded by the initiator 210 from the storage server 100. When the initiator 210 needs to download the target program from the storage server 100 again, it first determines whether the host cache 270 already has the target program. If so, then the initiator 210 reads the target program from the host cache 270. Otherwise, the initiator 210 downloads the target program from the storage server 100. After downloading the target program, the initiator 210 stores the target program to the host cache 270.

If the storage media 110 and the local disk 230 of the storage server 100 are both block devices, the host cache 270 may not store the complete target program. That is, the host cache 270 may not store all storage blocks of the target program, but only some of them. In this case, when the initiator 210 needs to read the target program again, it first determines whether the host cache 270 stores storage blocks of the target program. If the host cache 270 stores one or more storage blocks of the target program, the initiator 210 reads the storage blocks of the target program from the host cache 270, and downloads from the storage server 100 the other storage blocks of the target program and stores them in the host cache 270.

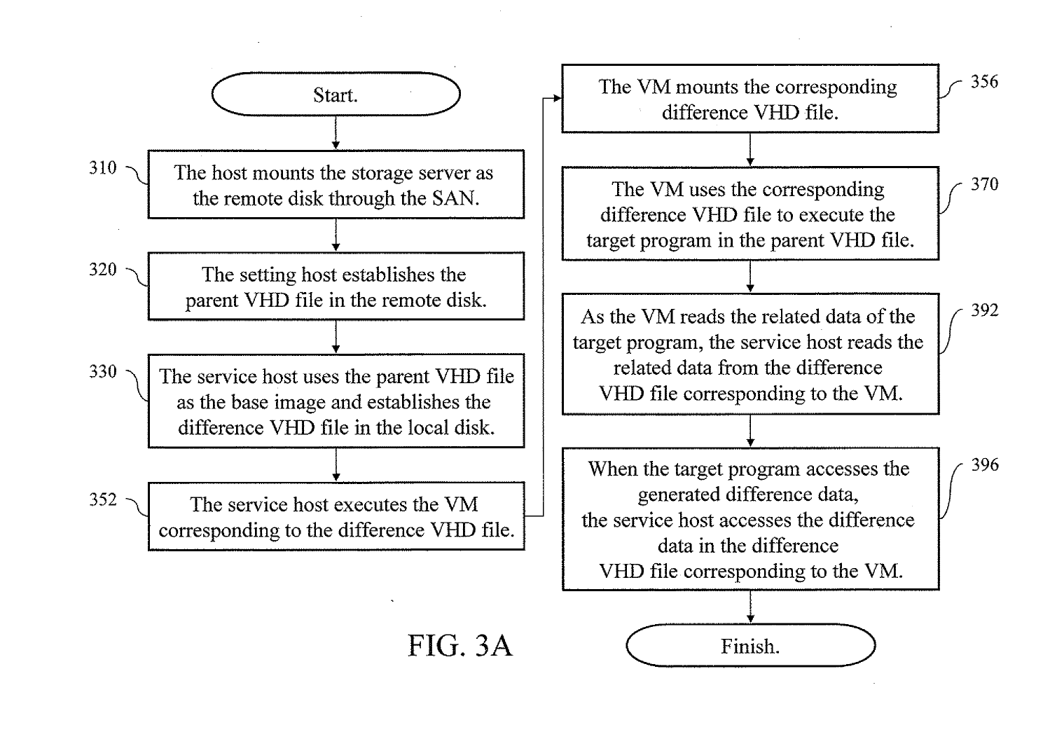

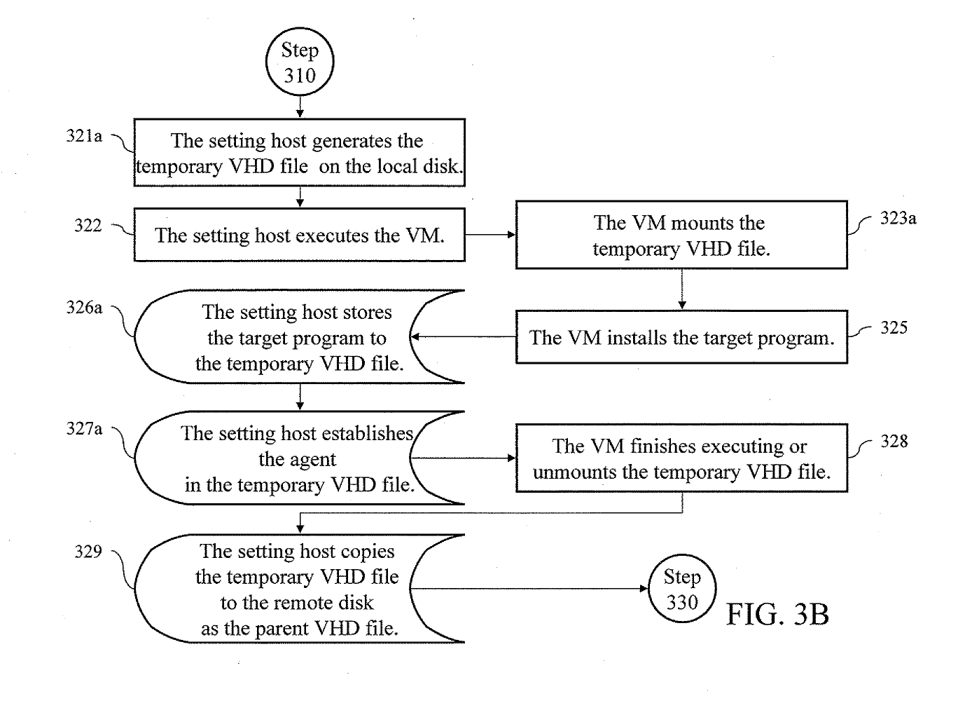

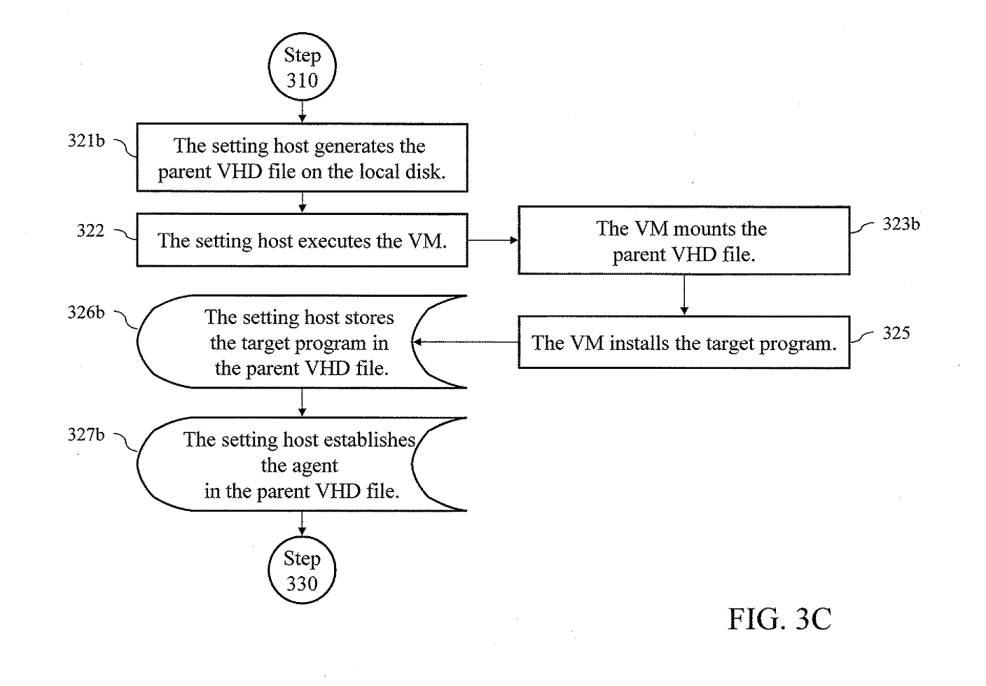

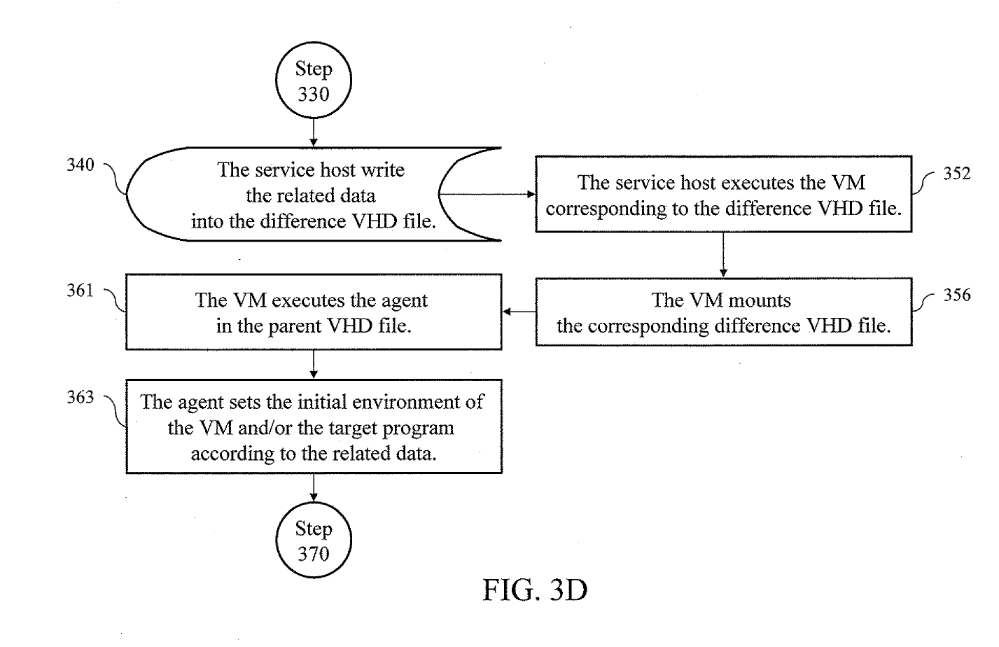

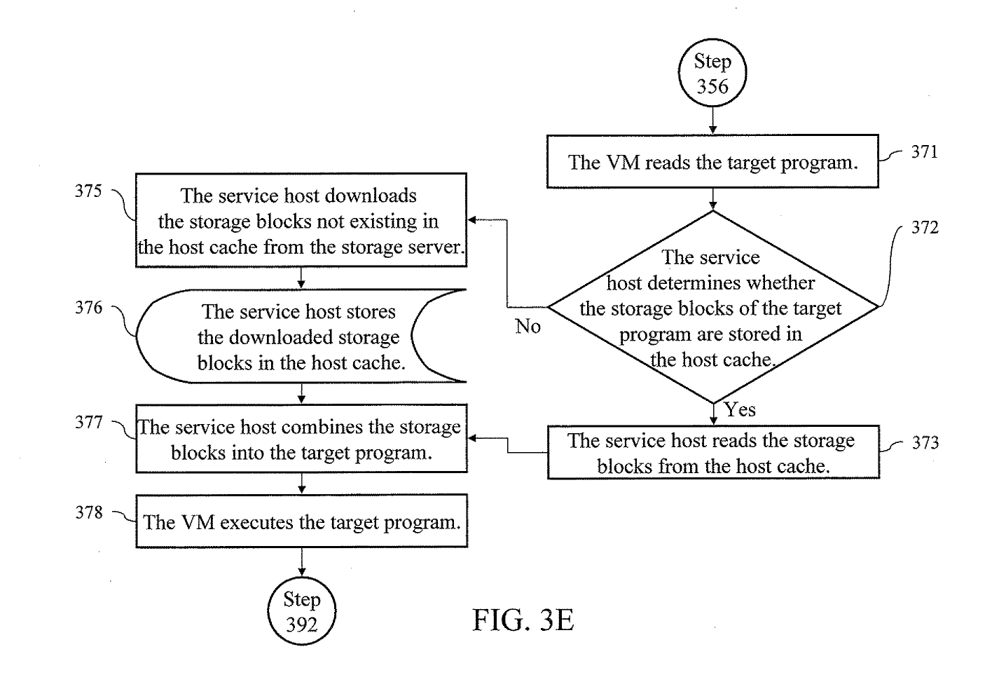

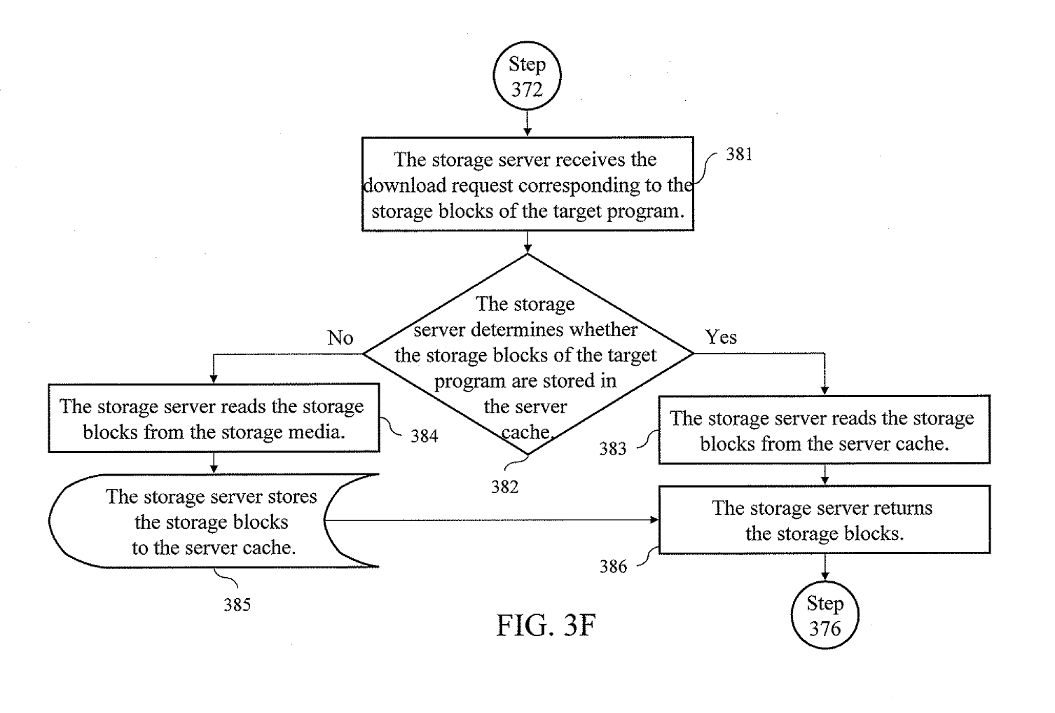

The following uses an embodiment to explain the disclosed system and method. Please refer to FIG. 3A for a flowchart of the disclosed method for reading the base image through the SAN. Suppose that there are a storage server 100 and at least one host 200 in this embodiment. The storage server 100 and the hosts 200 all support the invention. When there are too many hosts 200, the invention can contain two or more storage servers 100.

If the storage media 110 of the storage server 100 has not stored the parent VHD file 111 that can be the base image, then the manager needs to first establish a parent VHD file 111 that can be the base image. This means that the manager needs to operate one of the hosts 200 to establish a parent VHD file 111 that can be the base image. The host 200 used by the manager to establish a parent VHD file 111 that can be the base image is called the “setting host” in the invention.

First, the initiator 210 of the host is set to mount the storage media 110 of the storage server 100 through the SAN as the remote disk thereof (step 310). Afterwards, the VM processing module 250 of the host is set to establish in the remote disk a parent VHD file 111 that can be the base image (step 320).

In this embodiment, suppose the VM processing module 250 of the host runs as in FIG. 3B. It generates a temporary VHD file on the local disk 230 of the setting host (step 321a), and executes the VM (step 322).

After the VM is executed by the VM processing module 250, the VM can mount the temporary VHD file on the local disk 230 (step 323a). Afterwards, the manager can use the setting host to install target programs such as the OS and applications in the VM.

When the VM installs a target program (step 325), the VM processing module 250 of the setting host can store the installed target program to the temporary VHD file on the local disk 230 (step 326a). After the VM completes the target program installation, an agent is established in the temporary VHD file that stores the target program (step 327a). Finally, after the VM is terminated by the VM processing module 250 or the VM unmounts the VHD file (step 328a), the VM processing module 250 can copy the temporary VHD file containing the target program and the agent from the local disk 230 of the setting host to the remote disk thereof, producing the parent VHD file (step 329). In this way, the VM processing module 250 completes the establishment of the parent VHD file.

In fact, in this embodiment, the VM processing module 250 of the setting host can also follow the procedure in FIG. 3C. One can directly generate the parent VHD file 111 on the remote disk of the setting host (the storage media 110 of the storage server 100) via the initiator 210 of the setting host (step 321b), and then execute the VM (step 322). The VM mounts the parent VHD file on the remote disk afterwards (step 323b).

Later on, the manager can use the setting host to install target programs on the VM. When the VM installs a target program (step 325), the VM processing module 250 of the setting host can store the installed target program to the parent VHD file on the remote disk (step 326b). After the VM completes the target program installation, an agent is established in the parent VHD file containing the target program (step 327b). Thus, the VM processing module 250 establishes the parent VHD file containing the target program and the agent.

With reference to FIG. 3A again, the VM processing module 250 of the setting host is on the remote disk thereof. After the parent VHD file 111 is established in the storage media 110 of the storage server 100 (step 320), all hosts including the setting host can mount the storage media 110 of the storage server 100 as the remote disk of each of the hosts through the SAN (step 310). Since all of the hosts, including the setting host, can execute the VM, they are all referred to as the “service hosts” in the invention.

In this invention, the step of establishing a parent VHD file 111 on the remote disk by the VM processing module 250 of the setting host (step 320) and the step of mounting the storage media 110 of the storage server 100 as the remote disk of each of the hosts through the SAN (step 310) do not have a fixed order. That is, all of the hosts can first mount the storage media 110 of the storage server 100 as the remote disks thereof through the SAN (step 310). Afterwards, the VM processing module 250 of the setting host establishes the parent VHD file 111 on the remote disk (step 320).

In this invention, the steps executed by the service hosts (i.e., all hosts) are the same. Therefore, the subsequent description will concentrate on a single service host.

After the hosts respectively mount the storage media 110 of the storage server 100 as the remote disks thereof through the SAN (step 310) and the setting host establishes the parent VHD file 111 on the remote disk thereof (step 320), the VM 250 of the service host can use the parent VHD file 111 on the remote disk as the base image and establishes a difference VHD file 231 on the local disk 230 of the service host (step 330).

In practice, the VM processing module 250 of the service host can establish multiple difference VHD files 231, each of which corresponds to a distinct VM. In this invention, each VM operates in the same way. Therefore, this embodiment only describes one VM.

Suppose the VM processing module 250 of the service host executes the VM 251 corresponding to the difference VHD file 231 (step 352). If the VM processing module 250 of the service host has not executed the VM 251 corresponding to the established difference VHD file 231, as shown in FIG. 3D, the VM processing module 250 of the service host can first writes the data related to the target program in the parent VHD file 111 on the remote disk of the service host into the difference VHD file 231 (step 340). In this embodiment, the VM processing module 250 of the service host can execute such tools as diskpart, mounting the difference VHD file 231 as the hard disk of the service host. It further writes in the hard disk produced as the service host mounts the difference VHD file 231 the name of VM corresponding to the difference VHD file 231, the domain access privilege of the OS, the user privilege on the remote desktop program. The data related to the target program in the parent VHD file 111 are written into the difference VHD file 231.

Only after writing the related data into the difference VHD file (step 340), can the VM processing module 250 of the service host executes the VM 251 corresponding to the difference VHD file 231 that is written with related data (step 352). After being executed by the VM processing module 250 of the service host, the corresponding difference VHD file 231 can be mounted (step 356), thereby generating a hard disk in the VM 251. Since the difference VHD file 231 uses the parent VHD file 111 on the remote disk of the service host as the base image, the hard disk generated in the VM contains all the original data in the parent VHD file 111 and the difference data in the difference VHD file 231. The difference data in the difference VHD file 231 overwrite the original data in the parent VHD file 111 that has undergone a writing operation.

After the VM 251 mounts the corresponding difference VHD file 231 (step 356), the VM 251 can execute the agent in the parent VHD file 111 on the remote disk (step 361). For the VM 251, this means the execution of the agent contained in the hard disk generated in the VM 251.

After the agent is executed in the VM, the related data stored in the difference VHD file 231 can be used to set the initial environment of the VM 251 and/or the target program (step 363) so that the VM 251 can operate normally. The OS and applications in the hard disk generated by the VM can thus run normally. That is, the target programs in the parent VHD file 111 on the remote disk are executed (step 370) for the VM user to operate the VM. In this invention, the agent is supposed to set the name of the VM, the access privilege of the domain of the OS, and the user privilege of the remote desktop software in the OS.

With reference to FIG. 3A, if the VM processing module 250 has executed the VM 251 corresponding to the established difference VHD file 231 in step 352, then the VM 251 can mount the corresponding difference VHD file 231 (step 356) after the VM processing module 250 of the service host executes the VM 251 (step 352) so that the VM 251 generates the hard disk according to the difference VHD file 231. Afterwards, the VM 251 can execute the target programs in the parent VHD file 111 on the remote disk of the service host (step 370). For the VM 251, this means the execution of the target programs of OS and application on the hard disk generated in the VM 251. So the VM 251 can operate normally for the user to use.

When the VM 251 executes a target program (step 370), if the VM 251 or the target program needs to read related data, such as recording the environment setting values in the setting file, and the related data being read have not undergone the writing operation, then the related data are not stored in the difference VHD file 231 but the original data stored in the parent VHD file 111. The VM processing module 250 of the service host can download the related data from the storage server 100 via the initiator 210 of the service host. For example, the initiator 210 sends out a download request for the related data to the storage server 100. The target 130 of the storage server 100 follows the download request to read out the related data from the storage media 110 of the storage server 100 and to send them back to the service host. If the related data being read have undergone the writing operation, then the related data are the difference data stored in the difference VHD file 231. The VM processing module 250 of the service host can read the related data from the difference VHD file 231 (step 392).

When the VM 251 executes a target program (step 370), the target program needs to access the generated difference data on the hard disk generated on the VM 251. In this embodiment, suppose the target program produces buffer data that need to be saved. The VM processing module 250 of the service host can store the buffer data (difference data) to the difference VHD file 231 corresponding to the VM 251. Alternatively, when the target program needs to read out the buffer data, the VM processing module 250 can read the buffer data required by the target program from the difference VHD file 231 corresponding to the VM 251 (step 396).

As one or more VM's of the service host are running, if the target programs run by the VM's store the difference data in the hard disks of the corresponding VM's, then the VM processing module 250 of the service host writes the difference data produced by respective target programs into the difference VHD files corresponding to the VM's running the target programs. That is, the VM processing module 250 of the service host stores the difference data in the local disk 230 thereof. Suppose that each VM or each target program in each VM needs to read related data. If the difference VHD corresponding to the VM has the related data, the VM processing module 250 of the service host reads the related data for the target program from the difference VHD file of the VM. That is, the VM processing module 250 of the service host reads the difference data from the local disk 230 of the service host. If the difference VHD file corresponding to the VM does not contain the related data, which case the related data are the original data stored in the parent VHD file, the VM processing module 250 of the service host downloads the original data from the storage server 100 through the initiator 210 of the service host.

Likewise, when the VM user installs a new application in the VM, the new application becomes the difference data. The VM installs the new application in the hard disk that mounts the difference VHD file, so that the VM processing module 250 of the service host writes the new application into the difference VHD file corresponding to the VM stored in the local disk 230 of the service host. Afterwards, when the new application is executed by the VM, the VM processing module 250 of the service host reads in the newly installed application from the difference VHD file corresponding to the VM stored in the local disk 230 of the service host. When the VM executes the target program originally installed in the base image of the corresponding difference VHD file, the VM processing module 250 of the service host downloads the target program from the storage server 100 through the initiator 210. For example, the initiator 210 sends a download request for the target program to the storage server 100. The target 130 of the storage server 100 follows the download request to read out the target program from the storage media 110 of the storage server 100 and to send it back to the service host.

In the above-mentioned embodiment, suppose that the service host further includes the host cache 270. In this case, when the VM processing module 250 of the service host downloads the target program or the related data thereof from the storage server 100 through the initiator 210 of the service host, the initiator 210 can first determine whether the host cache 270 stores the target program or the related data before downloading. If so, then the initiator 210 directly reads the target program or related from the host cache 270, and provides the data to the VM processing module 250 of the service host. Otherwise, the initiator 210 downloads the target program or the related data from the storage server 100.

Now suppose that the local disk 230 of the service host and the storage media 110 of the storage server 100 are both block devices. As shown in FIG. 3E, when the VM reads the target program or the target programs reads the related data (original data) (step 371), the VM processing module 250 of the service host can download the target program or related data through the initiator 210 thereof. The initiator 210 determines whether the host cache 270 contains any storage blocks that store the target program or related data (step 372). If so, the initiator 210 reads out the storage blocks of the target program or related data from the host cache 270 (step 373). Afterwards, the initiator 210 can send the download request for the storage blocks of the target program or related that do not exist in the host cache 270 to the storage server 100, thereby downloading those storage blocks (step 375). In this embodiment, suppose the target program or the related data are distributed over two storage blocks, and the host cache 270 stores one of the storage blocks. After the initiator 210 determines that the host cache 270 stores one of the storage blocks, the initiator 210 reads out the storage block from the host cache 270 and sends the download request for the other storage block to the storage server 100 to download it.

After receiving the storage blocks of the target program or related data returned from the target 130 of the storage server 100, the initiator 210 can store the received storage blocks to the host cache 270 (step 376). The storage blocks read from the host cache 270 and the storage blocks received from the target 130 are then combined into the target program or related data (step 377). The VM processing module 250 can thus provide the target program or related to the VM (step 378).

In the above-mentioned embodiment, suppose that the storage server 100 further includes the server cache 150. When the VM processing module 250 of the service host downloads the target program or the related data of the target program from the storage server 100 through the initiator 210 of the service host, the target 130 of the storage server 100 can first determine whether the server cache 150 contains the target program or related data before downloading. If so, then the target can directly reads the target program or related data from the server cache 150 and send the data back to the service host. Otherwise, the target 130 reads the target program or related data from the storage media 110 of the storage server 100.

Suppose the local disk 230 of the service host and the storage media 110 of the storage server 100 are both block devices. As shown in FIG. 3F, after receiving the download request for the storage blocks of the target program or related data sent from the initiator 210 of the service host, the target 130 of the storage server 100 can first determine whether the server host 150 stores any storage blocks of the target program or related data (step 382). If so, the target 130 can directly read the storage blocks of the target program or related data from the server cache 150 (step 383), and return the data to the service host (step 386). Afterwards, the target 130 can also read the storage blocks of the target program or related that do not exist in the server cache 150 from the storage media 110. The storage blocks read from the storage media 110 are stored in the server cache 150 (step 385). The storage blocks read from the storage media 110 are returned to the service host (step 386). In this embodiment, suppose the target program or related data are distributed over two storage blocks. If the server cache 150 stores one of the storage blocks, then the target 130 reads the storage block from the server cache 150 after determining that the server cache 150 stores one storage block, and sends it to the server host. The target 130 also reads the other storage block from the storage media 110, and sends it to the service host.

In summary, the invention differs from the prior in that the host the disclosed host establishes the parent VHD file in the storage server through the SAN. The parent VHD file is used as the base image to build the difference VHD file on the local disk. After the VM running on the host mounts the difference VHD file and when the VM executes the target program, the service host reads the original data in the parent VHD file via the SAN, and access the difference data generated by the target program in the difference VHD file of the local disk. This solves problem that having the base image and the difference disk on the same device is likely to reduce the access performance in the prior art. It also achieves the effect of enhancing the access performance of the storage server and increasing the number of VM's supported by the storage server.

Moreover, the disclosed method for reading the base image through the SAN can be implemented in hard, software and the combination thereof. It can also implemented in computer systems in a centralized way or distributed as different elements in several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for reading a base image through a storage area network (SAN) to enable at least one host running a virtual machine (VM) to read the base image on a storage server, with the hosts containing one setting host and at least one service hosts, the method comprising the steps of:
mounting the storage server as a remote disk for each of the hosts through the SAN;
establishing a parent virtual hard disk (VHD) file in the remote disk by the setting host;
using the parent VHD file as the base image to establish at least one difference VHD file in a local disk of each of the service hosts;
executing a virtual machine (VM) corresponding to one of the difference VHD files on at least one of the service hosts;
mounting the corresponding difference VHD file on the VM;
executing a target program in the parent VHD file by the VM through the corresponding difference VHD file;
when the VM reads related data related by the target program, reading the related data from the difference VHD file corresponding to the VM by the service host executing the VM; and
when the target program accesses generated difference data, accessing the difference data in the difference VHD file corresponding to the VM by the service host executing the VM.

2. The method of claim 1, wherein the step of executing a target program in the parent VHD file by the VM through the corresponding difference VHD file further includes the step of when the storage server determines that at least one storage block storing the target program is stored in a server cache, reading each of the storage blocks from the server cache.

3. The method of claim 1, wherein the step of executing a target program in the parent VHD file by the VM through the corresponding difference VHD file further includes the step of determining whether the storage blocks of the target program are stored in a host cache of the service host executing the VM and, if so, reading the storage blocks from the host cache by the service host or, if not, downloading the other storage blocks not existing in the host cache from the storage server by the service host and saving the downloaded storage blocks to the host cache.

4. The method of claim 1, wherein the step of establishing a parent VHD file in the remote disk by the setting host further includes the steps of generating a temporary VHD file on a local disk of the setting host by the setting host; executing a setting VM; after the setting VM mounts the temporary VHD file and when the setting VM installs the target program, storing the target program to the temporary VHD file and establishing an agent in the temporary VHD file; when the setting VM shuts down or unmounts the temporary VHD file, and copying the temporary VHD file to the remote disk as the parent VHD file.

5. The method of claim 1, wherein the step of establishing a parent VHD file in the remote disk by the setting host further includes the steps of generating the parent VHD file on the remote disk by the setting host; executing a setting VM; after the setting VM mounts the VHD file and the setting VM installs the target program, storing the target program to the parent VHD file; and establishing an agent in the parent VHD file.

6. The method of claim 1, wherein the step of executing a VM corresponding to one of the difference VHD files on at least one of the service hosts further includes the step of writing the related data to the difference VHD file by the service host executing the VM, and the step of executing a target program in the parent VHD file by the VM through the corresponding difference VHD file is preceded by the step of executing an agent in the parent VHD file by the VM for the agent to set the initial environment of the VM and/or the target program according to the related data.

7. A server for reading the base image through a SAN to provide at least one host running a VM to read the base image, the server comprising:
a storage media for storing a parent VHD file that contains a target program; and
a target for providing the host to mount the storage media as a remote disk through the SAN;
wherein the host uses the parent VHD file as the base image to establish at least one difference VHD file; and when a VM executed by the host uses the corresponding difference VHD file to execute the target program, the target sends the target program to the host.

8. The server of claim 7, wherein the server further includes a server cache for storing at least one storage block of the target program so that when the target sends the target program to the host, the target first determines whether the server cache stores the storage blocks and, if so, the target reads the storage blocks from the server cache and sends the storage blocks to the host.

9. A host for reading the base image through a SAN, comprising:
an initiator, which mounts a storage media of a storage server as a remote disk through the SAN, the storage media storing a parent VHD file that contains a target program, and the initiator downloads the target program;
a local disk, which stores at least one difference VHD file, each of which is established based on the parent VHD file; and
a VM processing module, which executes a VM corresponding to one of the difference VHD files for executing the target program; when the VM reads related data of the target program, reads the related data from the difference VHD file corresponding to the VM; and, when the target program stores related difference data, stores the difference data into the difference VHD file corresponding to the VM.

10. The host of claim 9 further comprising a host cache, which stores at least one storage block stored the target program so that when downloading the target program, the initiator first determines whether the host cache stores the storage blocks and, if so, the initiator reads the storage blocks from the host cache or, if not, the initiator downloads the storage blocks not existing in the host cache and saves the downloaded storage blocks in the host cache.

11. The host of claim 9, wherein the VM processing module further generates a temporary VHD file on the local disk and executes a setting VM; when the setting VM mounts the temporary VHD file and installs the target program, the VM processing module stores the target program to the temporary VHD file and establishes an agent therein; when the setting VM shuts down or unmounts the VHD file, the VM processing module copies the temporary VHD file to the remote disk as the parent VHD file and writes the related data into the difference VHD file; the setting VM executes the agent before executing the target program so that the agent sets the initial environment of the setting VM and/or the target program according to the related data.

12. The host of claim 9, wherein the VM processing module further generates the parent VHD file in the remote disk and executes a setting VM; after the setting VM mounts the parent VHD file and installs the target program, the VM processing module stores the target program to the parent VHD file and establishes an agent therein and writes the related data into the difference VHD file; and the setting VM first executes the agent before executing the target program so that the agent sets the initial environment of the setting VM and/or target program according to the related data.
